(19) United States
(12) Patent Application Publication
(10) Pub. No.: US 2024/0417629 A1
(43) Pub. Date: Dec. 19, 2024

(54) PROCESS FOR PURIFYING A PYROLYSIS OIL AND PURIFICATION SYSTEM

(71) Applicant: BASF SE, Ludwigshafen am Rhein (DE)

(72) Inventors: Gisela HIEBER, Ludwigshafen am Rhein (DE); Fulvio Giacomo BRUNETTI, Ludwigshafen am Rhein (DE); Armin LANGE DE OLIVEIRA, Heidelberg (DE); Daniel KOEPKE, Ludwigshafen am Rhein (DE); Christian MUELLER, Ludwigshafen am Rhein (DE); Monica HAAG, Ludwigshafen am Rhein (DE); Michael SCHREIBER, Ludwigshafen am Rhein (DE); Oliver PILARSKI, Ludwigshafen am Rhein (DE); Lisa LOEBNITZ, Ludwigshafen am Rhein (DE); Julian MEYER-KIRSCHNER, Ludwigshafen am Rhein (DE); Ralf BOEHLING, Ludwigshafen am Rhein (DE)

(21) Appl. No.: 18/700,328

(22) PCT Filed: Oct. 4, 2022
(86) PCT No.: PCT/EP2022/077525

§ 371 Date: Apr. 11, 2024

(30) Foreign Application Priority Data
Oct. 13, 2021 (EP) 21202317.0

(51) Int. Cl. C10G 25/05; B01D 15/08; B01J 20/18; B01J 20/28

(52) U.S. Cl. CPC C10G 25/05; B01D 15/08; B01J 20/18; B01J 20/28071; B01J 20/28073; B01J 20/28076; B01J 20/2808; C10G 2300/1003; C10G 2300/202

(57) ABSTRACT

A process for purifying a pyrolysis oil originating from pyrolysis of plastic waste is provided, wherein the process comprises a dehalogenation of the pyrolysis oil, wherein the dehalogenation comprises contacting the pyrolysis oil with one or more adsorption materials and/or subjecting the pyrolysis oil to a temperature of about 280° C. or more, wherein a halogen content of a resulting purified pyrolysis oil is about 55% or more lower compared to the halogen content of the untreated pyrolysis oil.

The present invention relates to a process for purifying a pyrolysis oil originating from the pyrolysis of plastic waste to obtain a purified pyrolysis oil having a reduced halogen content in relation to the provided pyrolysis oil.

The invention further relates to the use of said pyrolysis oil, e.g., as feedstock for a (steam) cracker or as feedstock for a partial oxidation unit to produce syngas.

Furthermore, the invention relates to a purification system for purifying pyrolysis oil originating from pyrolysis of plastic waste.

Currently, plastic waste is still largely landfilled or incinerated for heat generation. Chemical recycling is an attractive way to convert waste plastic material into useful chemicals. An important technique for chemically recycling plastic waste is pyrolysis. The pyrolysis is a thermal degradation of plastic waste in an inert atmosphere and yields value added products such as pyrolysis gas, liquid pyrolysis oil and char (residue), wherein pyrolysis oil is the major product. The pyrolysis gas and char can be used as fuel for generating heat, e.g., for reactor heating purposes. The pyrolysis oil can be used as source for syngas production and/or processed into chemical feedstock such as ethylene, propylene, C4 cuts, etc. for example in a (steam) cracker.

Typically, the plastic waste is mixed plastic waste composed of different types of polymers. The polymers are often composed of carbon and hydrogen in combination with other elements such as halogens that complicate recycling efforts. In particular halogens may be harmful during the further processing of the crude pyrolysis oil, since they may cause corrosion, and deactivate or poison catalysts used in the further processing of the pyrolysis oil or cause plugging by the formation of ammonium halide. During (steam) cracking, halogen-containing compounds can damage the cracker by corrosion in that they release hydrogen halide.

When mixed plastics containing polyvinyl chloride (PVC) is thermally degraded, compounds having double carbon bonds and hydrogen chloride are formed. The hydrogen chloride liberated from PVC attacks the compounds having carbon-carbon double bonds leading to the formation of chloroorganic compounds.

Furthermore, plastic waste typically contains heteroatom-containing additives such as flame retardants, stabilizers and plasticizers that have been incorporated to improve the performance of the polymers. Such additives also often comprise nitrogen, halogen and sulfur containing compounds and heavy metals.

Furthermore, plastic waste often may be uncleaned plastics with residue that may also contain elements other carbon and hydrogen, in particular additional halogen-containing substances.

Therefore, the reduction of the amount of undesired substances such as halogens in the pyrolysis oil is essential for any profit-generating processing of the pyrolysis oil. In particular, a high-quality pyrolysis oil which is rich in carbon and hydrogen and low in elements other than carbon and hydrogen is preferred as feedstock to prevent catalyst deactivation and corrosion problems in downstream refinery processes.

Accordingly, a process for upgrading plastic waste pyrolysis oil by reducing in particular the halogen content in the pyrolysis oil would be highly desirable. Furthermore, it would be desirable to provide a high-quality plastic waste pyrolysis oil that can be converted into high-value end products in an economic process.

In view of the above, it is an object of the present invention to provide for a process which allows for a purification of pyrolysis oil and which is as easy as possible.

This object is solved by a process according to claim 1.

A process for purifying a pyrolysis oil originating from pyrolysis of plastic waste is provided, which comprises a dehalogenation of the pyrolysis oil.

The dehalogenation comprises:
contacting the pyrolysis oil with one or more adsorption materials and/or
subjecting the pyrolysis oil to a temperature of about 280° C. or more.

A halogen content of a resulting purified pyrolysis oil is preferably about 55% or more lower compared to the halogen content of the untreated pyrolysis oil.

“55% or more lower” means particularly that the halogen content of the purified pyrolysis oil is less than 45% of the halogen content of the pyrolysis oil before dehalogenation.

Preferably, the halogen content of a resulting purified pyrolysis oil is about 60% or more lower compared to the halogen content of the untreated pyrolysis oil. Thus, the halogen content of the purified pyrolysis oil is particularly less than 40% of the halogen content of the pyrolysis oil before dehalogenation.

According to the process of the present invention, either a pure thermal dehalogenation or a dehalogenation by the use of one or more adsorption materials is performed.

The term “untreated pyrolysis oil” refers to the pyrolysis oil in a state before the process according to the present invention has been performed. The untreated pyrolysis oil can also be referred to as “crude pyrolysis oil” or “original pyrolysis oil”.

The “untreated pyrolysis oil”, “crude pyrolysis oil” and/or “original pyrolysis oil” is preferably a pyrolysis oil which has already been subjected to a first filtration and/or extraction. However, the “untreated pyrolysis oil”, “crude pyrolysis oil” and/or “original pyrolysis oil” can also be a pyrolysis oil directly resulting from the pyrolysis process.

In the context of the present invention, the term “pyrolysis” relates to a thermal decomposition or degradation of end-of-life plastics under inert conditions and results in a gas, a liquid and a solid char fraction. During the pyrolysis, the plastics are converted into a great variety of chemicals including gases such as H2, C1-C4-alkanes, C2-C4-alkenes, ethyne, propyne, 1-butyne, pyrolysis oil having a boiling temperature of 25° C. to 500° C. and char. The term “pyrolysis” includes slow pyrolysis, fast pyrolysis, flash catalysis and catalytic pyrolysis. These pyrolysis types differ regarding process temperature, heating rate, residence time, feed particle size, etc. resulting in different product quality.

In the context of the present invention, the term “pyrolysis oil” is understood to mean any oil originating from the pyrolysis of plastic waste. The pyrolysis oil is obtained and/or obtainable from pyrolysis of plastic waste.

In the context of the present invention, the term “plastic waste” refers to any plastic material discarded after use, i.e., the plastic material has reached the end of its useful life. The plastic waste can be pure polymeric plastic waste, mixed plastic waste or film waste, including soiling, adhesive materials, fillers, residues etc. The plastic waste has a nitrogen content, sulfur content, halogen content and optionally also a heavy metal content. The plastic waste can originate from any plastic material containing source. Accordingly, the term “plastic waste” includes industrial and domestic plastic waste including used tires and agricultural and horticultural plastic material. The term “plastic waste” also includes used petroleum-based hydrocarbon material such as used motor oil, machine oil, greases, waxes, etc.

Typically, plastic waste is a mixture of different plastic material, including hydrocarbon plastics, e.g., polyolefins such as polyethylene (HDPE, LDPE) and polypropylene, polystyrene and copolymers thereof, etc., and polymers composed of carbon, hydrogen and other elements such as chlorine, fluorine, oxygen, nitrogen, sulfur, silicone, etc., for example chlorinated plastics, such as polyvinylchloride (PVC), polyvinylidene chloride (PVDC), etc., nitrogen-containing plastics, such as polyamides (PA), polyurethanes (PU), acrylonitrile butadiene styrene (ABS), etc., oxygen-containing plastics such as polyesters, e.g., polyethylene terephthalate (PET), polycarbonate (PC), etc.), silicones and/or sulfur bridges crosslinked rubbers. PET plastic waste is often sorted out before pyrolysis, since PET has a profitable resale value. Accordingly, the plastic waste to be pyrolyzed often contains less than about 10 wt.-%, preferably less than about 5% by weight and most preferably substantially no PET based on the dry weight of the plastic material. One of the major components of waste from electric and electronic equipment are polychlorinated biphenyls (PCB). Typically, the plastic material comprises additives, such as processing aids, plasticizers, flame retardants, pigments, light stabilizers, lubricants, impact modifiers, antistatic agents, antioxidants, etc. These additives may comprise elements other than carbon and hydrogen. For example, bromine is mainly found in connection to flame retardants. Heavy metal compounds may be used as lightfast pigments and/or stabilizers in plastics; cadmium, zinc and lead may be present in heat stabilizers and slip agents used in plastics manufacturing. The plastic waste can also contain residues. Residues in the sense of the invention are contaminants adhering to the plastic waste. The additives and residues are usually present in an amount of less than 50 wt.-%, preferably less than 30 wt.-%, more preferably less than 20 wt.-%, even more preferably less than 10% by weight based on the total weight of the dry weight plastic.

As already mentioned, according to the process according to the present invention, the pyrolysis oil is subjected to a temperature. Preferably, the temperature the pyrolysis oil is subjected to is set to about 500° C. or less.

The mentioned temperatures are high enough to perform a dehalogenation with desired purification results and/or low enough to be economically efficient.

Preferably no separate catalyst (except for eventually used adsorption materials) is used for and/or during the dehalogenation.

In particular, the one or more adsorption materials are essentially nickel-free.

The term “halogen” denotes in each case one or more selected from fluorine, bromine, chlorine and iodine.

“Dehalogenation” denotes a reduction of a halogen content compared to the halogen content of the substance before the dehalogenation is performed.

Surprisingly it has been found that the dehalogenation is enhanced if a gas pressure is applied on the pyrolysis oil during the (dehalogenation) reaction. The finding that the chemical dehalogenation reaction is faster and/or its reaction yield is increased by the application of a physical gas pressure is unexpected.

According to a preferred embodiment, the dehalogenation is performed in a reaction chamber at a gas pressure, for example a hydrogen pressure or a nitrogen pressure, of about 10 bar or more, preferably about 50 bar or more, for example about 75 bar or more.

Preferably, the gas pressure is about 150 bar or less, preferably about 100 bar or less, for example about 85 bar or less.

The application of hydrogen pressure compared with the application of nitrogen pressure leads to an even enhanced dehalogenation (if the remaining reaction conditions are the same). An enhanced dehalogenation particularly denotes an increased reduction of the halogen content.

Preferably, one or more of the one or more adsorption materials is a molecular sieve, in particular activated charcoal or a zeolite, an alumina material, in particular a silica-alumina material, for example a silica-alumina hydrate.

In the context of the present description and the accompanying claims, “zeolites” are microporous, aluminosilicate minerals which are commercially available under the term “zeolite”. In particular, zeolites have a porous structure that can accommodate a wide variety of cations, such as sodium ions, potassium ions, calcium ions, magnesium ions and others. These positive ions are rather loosely held and can readily be exchanged for others in a contact solution.

Particularly preferred as adsorption materials are silica-alumina hydrates having a ratio between alumina (Al₂O₃) and silica (SiO₂) of about 1:1 or more and/or about 2:1 or less, for example about 3:2.

According to a further preferred embodiment, a molecular sieve is used as adsorption material which is an alumosilicate. For example, a ratio between alumina and silica is 0.5:2 and 1.5:2. Preferably, the alumosilicate contains one or more of the following oxides: potassium oxide, sodium oxide and/or calcium oxide.

For example, a loose bulk density of the adsorption material is 200 g/l or more and/or about 800 g/l or less.

The inventors have observed that it is beneficial if the dehalogenation is performed for about 2 minutes or more, preferably about 10 minutes or more, more preferably for about 2 hours or more, in particular for about 10 hours or more.

For optimized results, a weight ratio between the pyrolysis oil and the one or more adsorption materials is about 10:1 or more, preferably 17:1 or more, and/or about 100:1 or less, preferably about 24:1 or less.

For optimized dehalogenation results, the temperature of the pyrolysis oil during the dehalogenation is preferably about 300° C. or more, preferably about 350° C. or more, in particular about 375° C. or more, for example about 400° C. or more.

It is beneficial if one or more of the one or more adsorption materials is a particulate material, wherein preferably an average particle size d50 of particulate adsorption material is about 25000 μm or less, preferably about 6500 μm or less, preferably about 2000 μm or less, in particular about 500 μm or less, for example about 50 μm or less.

Preferably, the average particle size d50 of the adsorption material is about 10 μm or more.

The average particle size d50 is preferably determined by optical methods or by an air sieve, for example by various instruments, namely, Cilas Granulometer 1064 supplied by Quantachrome, Malvern Mastersizer or Luftstrahlsieb (air sieve) supplied by Alpine.

Preferably, one or more of the one or more adsorption materials has an average pore volume of about 0.2 ml/g to about 2.0 ml/g.

In particular, one or more of the one or more adsorption materials has an average pore size of about 1 Å to about 15 Å.

For example, one or more of the one or more adsorption materials has a surface area (BET) of about 300 m²/g to about 900 m²/g.

The surface area of the respective adsorption material is measured by using an instrument supplied by Quantachrome (Nova series) or by Micromeritics (Gemini series). The method entails low temperature adsorption of nitrogen at the BET region of the adsorption isotherm.

The dehalogenation is preferably performed partially or entirely in a reaction chamber which is hermetically sealable and/or hermetically sealed during dehalogenation.

For example, the dehalogenation is performed in an autoclave reactor or another reactor which is gas tight if an inlet and an outlet are closed.

According to another example, a purification system having one or more valves is used so that the reaction chamber is sealable in order to control the pressure and/or apply a particular pressure.

It is possible that a capillary tube reactor forms the reaction chamber. This will be described in more detail below.

Preferably, in case the pyrolysis oil is a waxy pyrolysis oil, the pyrolysis oil is preheated in a preheating device, for example to a temperature of about 50° C. to about 100° C., before it is supplied to the reaction chamber. The preheating device for example comprises a temperature adjustment element, for example a thermostat. It is possible, that the preheating device comprises a stirring element or is formed by a stirring reactor.

According to a preferred embodiment, the process is a continuous process and/or automatically controllable process.

A mentioned above, the invention further relates to a purification system.

In this regard, it is an object of the present invention to provide for a purification system with which a dehalogenation of pyrolysis oil can be conducted.

This object is solved by the purification system of the independent claim directed to a purification system.

The purification system is adapted for purifying pyrolysis oil originating from pyrolysis of plastic waste, for example for performing a process according to the present invention.

The purification system comprises:
a reaction chamber for accommodating pyrolysis oil and/or one or more adsorption materials;
a pyrolysis oil supply for supplying pyrolysis oil into the reaction chamber;
a temperature control element for adjusting the temperature of the pyrolysis oil in the reaction chamber to a temperature of about 280° C. or more.

The purification system is designed and/or arranged in such a way that a halogen content of a resulting purified pyrolysis oil after purification is about 55% or more lower, preferably about 60% or more lower, compared to the halogen content of the untreated pyrolysis oil.

Preferably, one or more of the features and/or advantages described in connection with the process according to the present invention are valid regarding the purification system of the present invention, too.

The pyrolysis oil supply is preferably a pyrolysis oil supply line.

Preferably, the reaction chamber is part of a reactor, for example a capillary tube reactor. For example, the temperature control element comprises at least one heating element for adjusting the temperature of the pyrolysis oil in the reaction chamber, in particular for heating the pyrolysis oil.

According to a preferred embodiment, the reaction chamber is formed by a cavity surrounded by a capillary tube reactor.

Preferably, the reactor of which the reaction chamber is a part, is a capillary tube reactor. However, also other reactors can be suitable, for example a fixed bed reactor, for example a trickle bed reactor, a tubular fixed bed reactor, or a slurry reactor, for example a tubular slurry reactor, or a simple reaction vessel.

For example, the capillary tube has a helical form and/or is formed spirally.

According to a preferred embodiment, the temperature control element comprises a heat transfer medium which surrounds the reaction chamber, for example the capillary tube reactor. By increasing the temperature of the heat transfer medium, the temperature of the pyrolysis oil in the reaction chamber can be increased. Thus, an indirect temperature adjustment of the pyrolysis oil in the reaction chamber can be realized.

Preferred examples for the heat transfer medium are oil, air, vapor or nitrogen. However, also salts in a liquid state can be used as heat transfer medium or heating can be applied electrically.

Concerning capillary tube reactors, a diameter of the capillary tube is preferably about 0.5 mm to about 10 mm.

The purification system preferably comprises a preheating device. For example, the preheating device comprises or is a stirring device. Preferably, the preheating device comprises a temperature adjustment element for preheating the pyrolysis oil before it is supplied to the reaction chamber.

It is beneficial, if the preheating device is in a direction of flow of the pyrolysis oil arranged upstream of the reaction chamber and/or wherein the preheating device is fluidically connected with the reaction chamber.

Preferably, the purification system further comprises one or more conveying elements, for example one or more pumps, for transporting the pyrolysis oil through the purification system, preferably continuously.

Preferably, the pyrolysis oil is transported through the purification system so that a desired residence time of several minutes up to several hours results.

According to a preferred embodiment, the purification system comprises a pressurizing system for application of a controlled gas pressure in the reaction chamber, wherein the pressurizing system comprises one or more gas lines which are fluidically connected with the reaction chamber, for example a hydrogen supply line and/or a nitrogen supply line.

Preferably, the purification system comprises one or more safety elements which interrupt operation of the purification system in case the temperature and/or pressure in the reaction chamber exceeds a critical temperature and/or a critical pressure. In addition or in the alternative, the safety element interrupts operation of the purification system in case the pressure falls below a minimum pressure and thus, indicating a leak.

Furthermore, the present invention relates to the use of a purified pyrolysis oil obtainable or obtained by a process in accordance with the invention as feedstock for a cracker, preferably a steam cracker, or as feedstock for a partial oxidation unit to produce syngas.

For the purposes of producing advantageous embodiments of the invention, particular ones or several of the features described in this description and the accompanying claims can be utilized or omitted at will in combination with further features or independently of further features.

Further preferred features and/or advantages of the present invention form the subject matter of the following description and the graphical illustration of an exemplary embodiment.

In the drawing:

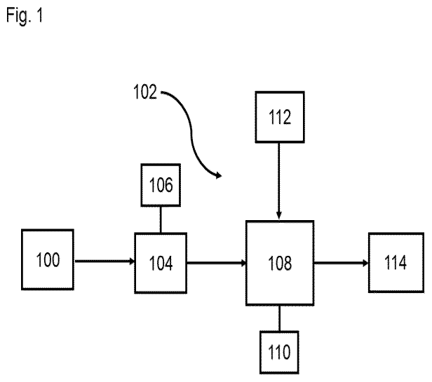

FIG. 1 shows schematically an embodiment of a process for purifying a pyrolysis oil originating from pyrolysis of plastic waste in a purification system which is presently operated continuously.

In FIG. 1 an embodiment of a process for purifying a pyrolysis oil 100 by dehalogenation is shown.

According to the embodiment described in the following, a purification system 102 is used, wherein the purification system 102 is arranged in a way that the process can be performed as a continuous process.

The process is preferably automatically controllable.

The process is preferably used for purifying the pyrolysis oil 100 before further use. A preferred use of the pyrolysis oil treated by the process is the use in a cracker, for example a steam cracker, or in a partial oxidation unit for the production of syngas (both not graphically shown).

Thus, the pyrolysis oil can be used as source for syngas production and/or processed into chemical feedstock such as ethylene, propylene, C4 cuts, etc. for example in a cracker, for example in a steam cracker.

Typically, the original pyrolysis oil 100 has a halogen content of about 10 mg/kg or more, often about 40 mg/kg or more, for example about 80 mg/kg or more.

Typically, the original pyrolysis oil 100 has a halogen content of about 1500 mg/kg or less, often about 1000 mg/kg or less, for example about 800 mg/kg or less.

The halogen content is presently determined by elemental analysis, for example using coulometric titration.

The purification system 102 presently comprises a preheating device 104 for preheating the original pyrolysis oil 100. Presently, the untreated pyrolysis oil 100 is supplied to the preheating device 104, for example through a supply line.

The preheating device 104 preferably comprises a temperature adjustment element 106, for example a thermostat, for adjusting the temperature of the original pyrolysis oil 100. Presently, the temperature of the untreated pyrolysis oil is adjusted to a temperature of about 40° C. or more, in particular about 50° C. or more, for example about 60° C. or more.

However, in case the pyrolysis oil 100 is liquid at room temperature, a preheating is dispensable.

Preferably, the temperature of the untreated pyrolysis oil 100 is adjusted by the temperature adjustment element 106 of the preheating device 104 to about 100° C. or less, in particular about 90° C. or less, for example about 80° C. or less.

It is beneficial if the preheating device 104 comprises a stirring element and/or is a stirring tank reactor. Thus, the temperature and composition of the untreated pyrolysis oil 100 can be homogenized over the whole reaction volume.

Presently, after preheating, the (preheated) pyrolysis oil 100 is conducted and/or transferred to a reaction chamber 108 of the purification system 102, for example through further supply lines.

As can be seen in FIG. 1, the preheating device 104 is in a direction of flow of the pyrolysis oil arranged upstream of the reaction chamber 108. The preheating device 104 is presently fluidically connected with the reaction chamber 108.

For transfer of the pyrolysis oil 100, the purification system 102 presently comprises one or more conveying elements, for example one or more pumps. In particular, the pyrolysis oil 100 is transferred continuously.

Preferably, the pyrolysis oil 100 is transported through the purification system 102 so that a desired residence time of several minutes up to several hours results.

The reaction chamber 108 is presently part of a reactor, for example a capillary tube reactor. For example, an inner diameter of the capillary tube is about 0.5 mm to about 10 mm.

However, also other reactors can be used to contain the reaction chamber 108, for example a fixed bed reactor, for example a tubular fixed bed reactor or a trickle bed reactor, or a slurry reactor, for example a tubular slurry reactor, or a simple reaction vessel.

The purification system 102 further comprises a temperature control element 110 for controlling the temperature of the pyrolysis oil 100. The temperature control element 110 comprises at least one heating element for adjusting the temperature of the pyrolysis oil 100 in the reaction chamber 108, in particular for heating the pyrolysis oil 100.

In embodiments in which the reaction chamber 108 is part of a capillary tube reactor, the reaction chamber 108 is preferably formed by the cavity of the capillary tube reactor. Preferably, the capillary tube reactor is helically formed and/or spirally bent.

Presently, the reaction chamber 108 is heated electrically.

Preferably, the temperature control element 110 comprises a heat transfer medium from which heat is transferred to the pyrolysis oil 100.

Presently, the heat transfer medium is nitrogen. However, also oil, vapor, salts (in a liquid state) or other gases, such as air, might be used as heat transfer medium.

According to the embodiment shown in FIG. 1, the heat transfer medium encloses the reaction chamber in form of the capillary tube. Due to the adjustment of the temperature of the heat transfer medium, the temperature of the pyrolysis oil 100 is adjusted indirectly.

Inside the reaction chamber 108, presently a dehalogenation of the pyrolysis oil 100 is performed.

In embodiments, in which the reaction chamber 108 is formed by a capillary tube reactor, the whole capillary tube forms a reaction space.

The pyrolysis oil 100 is presently heated up by the temperature control element 110 to a temperature of about 280° C. or more, preferably to about 300° C. or more, in particular to about 350° C. or more, in particular to about 375° C. or more, for example to about 400° C. or more.

Preferably, the pyrolysis oil 100 is in the reaction chamber 108 heated to a temperature of about 500° C. or less.

The pyrolysis oil 100 is preferably kept at the mentioned temperature for about 2 minutes or more, more preferably about 10 minutes or more, in particular for about 2 hrs. or more, for example for about 10 hrs. or more.

A reaction time, for example a holding time in the capillary tube, can be controlled by opening and/or closing an inlet into and/or an outlet from the reaction chamber 108. Preferably, the reaction time, for example the holding time in the capillary tube, can be controlled by a valve, for example by a three-way-valve. For example, the three-way-valve is positioned downstream of the reaction chamber 108 and connects the reaction chamber 108 with an interim storage element for storing pyrolysis oil that is discharged from the reaction chamber 108 (not graphically shown).

In the beginning of the process, the inlet is brought into an open state (for example by opening or closing a valve) so that the reaction chamber 108 can be filled with the pyrolysis oil 100. After the reaction chamber 108 is filled, the inlet is set to a closed position state (for example by closing a valve). The pyrolysis oil 100 is then treated in a dehalogenation.

After the dehalogenation has been completed to a desired level, preferably to a halogen content of about 150 mg/kg or less, more preferably about 30 mg/kg or less, an outlet is brought to an open state so that the purified pyrolysis oil can be removed from the reaction chamber 108, for example by opening or closing a valve. Afterwards, the outlet is brought into a closed state.

The dehalogenation can be performed at inherent pressure,

However, it can be beneficial if the dehalogenation is performed under a gas pressure of about 10 bar or more, in particular about 50 bar or more, for example at about 75 bar or more.

The gas pressure is preferably applied by gas supply lines of the purification system 102, for example a hydrogen supply line and/or a nitrogen supply line to the reaction chamber 108.

According to the embodiment of FIG. 1, the purification system 102 comprises a pressurizing system for application of a controlled gas pressure in the reaction chamber, wherein the pressurizing system comprises one or more gas lines which are fluidically connected with the reaction chamber 108, for example the mentioned hydrogen supply line and/or the mentioned nitrogen supply line.

Presently, the reaction chamber 108 is hermetically sealed and/or gas tight.

According to the embodiment of FIG. 1, the purification system 102 comprises a safety element which interrupts operation of the purification system 102 in case the temperature and/or pressure exceeds a critical temperature and/or a critical pressure. In addition or in the alternative, the safety element interrupts operation of the purification system 102 in case the pressure falls below a minimum pressure and thus, indicating a leak.

Preferably, during the dehalogenation, the pyrolysis oil 100 is contacted with one or more adsorption materials 112, presently in the reaction chamber 108.

Preferably, one or more of the one or more adsorption materials 112 is a molecular sieve, in particular activated charcoal or a zeolite, preferably an alumina material, in particular a silica-alumina material, for example a silica-alumina hydrate.

Particularly preferred as adsorption material 112 are silica-alumina hydrates having a ratio between alumina (Al₂O₃) and silica (SiO₂) of about 1:1 or more and/or about 2:1 or less, for example about 3:2.

According to this example, preferably, a loose bulk density of the adsorption material 112 is 200 g/l or more and/or about 500 g/l or less.

According to a further preferred embodiment, a molecular sieve is used as adsorption material which is an alumosilicate. For example, a ratio between alumina and silica is 0.5:2 and 1.5:2. Preferably, the alumosilicate contains one or more of the following oxides: potassium oxide, sodium oxide and/or calcium oxide.

For the mentioned alumosilicates, the loose bulk density is preferably 200 g/l or more and/or about 800 g/l or less.

Presently, one or more of the one or more adsorption materials 112 is a particulate material, wherein preferably an average particle size d50 of the particulate adsorption material 112 is 25000 μm or less, preferably about 6500 μm or less, preferably about 2000 μm or less, in particular about 500 μm or less, for example about 50 μm or less.

Preferably, the average particle size of the adsorption material 112 is about 10 μm or more.

The average particle size d50 is preferably determined by optical methods or by an air sieve, for example by various instruments, namely, Cilas Granulometer 1064 supplied by Quantachrome, Malvern Mastersizer or Luftstrahlsieb (air sieve) supplied by Alpine.

Additionally or in the alternative, one or more of the one or more adsorption materials 112 has one or more of the following properties:
an average pore volume of about 0.2 ml/g to about 2.0 ml/g; and/or
an average pore size of about 1 Å to about 15 Å; and/or
a surface area (BET) of about 300 m²/g to about 900 m²/g.

The surface area of the respective adsorption material 112 is measured by using an instrument supplied by Quantachrome (Nova series) or by Micromeritics (Gemini series). The method entails low temperature adsorption of nitrogen at the BET region of the adsorption isotherm.

A weight ratio between the pyrolysis oil 100 and the one or more adsorption materials 112 is preferably adjusted to be about 10:1 or more, preferably 17:1 or more, and/or about 100:1 or less, preferably about 24:1 or less.

According to a preferred example, the purification system 102 comprises a filter element which is arranged at a removal line and/or at the outlet of the reactor, through which the pyrolysis oil is removed from the reaction chamber 108 after the dehalogenation.

Independent from the location of the filter element, a filtration of the resulting pyrolysis oil is preferably performed after the dehalogenation. It is, however, possible, that no filtration is needed.

For further purification, an extraction of the pyrolysis oil can be performed, for example by using an extraction device (not graphically shown).

A resulting purified pyrolysis oil 114 is preferably cooled down before the described further treatment, such as filtration and/or extraction.

The halogen content of the resulting purified pyrolysis oil 114 is about 55% or more lower, preferably about 60% or more lower, compared to the halogen content of the untreated pyrolysis oil 110.

The invention will be described in more details by the subsequent examples.

### EXAMPLES

Abbreviations: hr(s) means hour(s); wt.-% means weight percent.

### Starting Materials:

Pyrolysis oils with varying nitrogen, sulfur and halogen contents were used as feedstock. The pyrolysis oils were prepared in analogy to the process described in EP 0713906.

The following pyrolysis oils were used:
pyrolysis oil 1 having a sulfur content of 6100 mg/kg, a nitrogen content of 3200 mg/kg and a halogen content of 190 mg/kg,
pyrolysis oil 2 having a sulfur content of 6100 mg/kg, a nitrogen content of 3200 ppm and a halogen content of 190 mg/kg,
pyrolysis oil 3 having a sulfur content of 400 mg/kg, a nitrogen content of 9000 mg/kg and a halogen content of 370 mg/kg.

### Product Analyses:

The halogen content (sum of the content of chlorine, bromine and iodine) is determined by combustion of the respective sample at about 1050° C. Resulting combustion gases, i.e., hydrogen chloride, hydrogen bromide and hydrogen iodide, are led into a cell in which coulometric titration a performed.

The nitrogen content is determined by combustion of the respective sample at about 1000° C. NO contained in resulting combustion gases reacts with ozone so that NO₂* is formed. Relaxation of excited nitrogen species is detected by chemiluminescence detectors.

The sulfur content is determined by combustion of the respective sample at about 1000° C. Sulfur dioxide which is contained in resulting combustion gases is excited by UV (ultraviolet) light. Light which is emitted during relaxation is detected by UV fluorescence detectors.

### Example 1

49.6 g pyrolysis oil 1 and 2.50 g of an adsorption material in the form of a molecular sieve 13X, obtained under the trade name Alfa Aesar™ from Fischer Scientific GmbH, 58239 Schwerte, Germany, are placed in an autoclave reactor. The autoclave reactor is hermetically sealed and a temperature of about 375° C. is applied for about 2 hrs. The process is performed under inherent pressure (without applying any gas pressure).

After this treatment, the pyrolysis oil is filtrated at a temperature of about 70° C. with a filter, preferably having an average mesh size of about 6 μm, presently under pressure.

The resulting pyrolysis oil has a sulfur content of about 5100 mg/kg, a nitrogen content of about 2500 mg/kg and a halogen content of about 21 mg/kg.

### Example 2

45.0 g pyrolysis oil 1 and 2.50 g of an adsorption material in the form of a molecular sieve 3A, obtained under the trade name ACROS Organics™ from Fischer Scientific GmbH, 58239 Schwerte, Germany, are placed in an autoclave reactor. The autoclave reactor is hermetically sealed and a temperature of about 375° C. is applied for about 2 hrs. The process is performed under inherent pressure (without applying any gas pressure).

The resulting pyrolysis oil has a sulfur content of about 5500 mg/kg, a nitrogen content of about 3200 mg/kg and a halogen content of about 22 mg/kg.

### Example 3

45.0 g pyrolysis oil 1 and 2.50 g of an adsorption material in the form of a zeolite, obtained under Alfa Aesar™ Zeolith-ZSM-5, Ammonium from Fischer Scientific GmbH, 58239 Schwerte, Germany, are placed in an autoclave reactor. The autoclave reactor is hermetically sealed and a temperature of about 375° C. is applied for about 2 hrs. The process is performed under inherent pressure (without applying any gas pressure).

After this treatment, the pyrolysis oil is filtrated at a temperature of about 70° C. with a filter, preferably having an average mesh size of about 6 μm, presently under pressure.

The resulting pyrolysis oil has a sulfur content of about 6200 mg/kg, a nitrogen content of about 3400 mg/kg and a halogen content of about 40 mg/kg.

### Example 4

49.4 g pyrolysis oil 1 and 2.50 g of an adsorption material in the form of molecular sieve 13X, obtained under the trade name Alfa Aesar™ from Fischer Scientific GmbH, 58239 Schwerte, Germany, are placed in an autoclave reactor. The autoclave reactor is hermetically sealed and a temperature of about 375° C. is applied for about 2 hrs. The process is performed under a hydrogen pressure of about 80 bar. Before the hydrogen pressure is applied, the autoclave reactor is heated to about 375° C.

After this treatment, the pyrolysis oil is filtrated at a temperature of about 70° C. with a filter, preferably having an average mesh size of about 6 μm, presently under pressure.

The resulting pyrolysis oil has a sulfur content of about 5300 mg/kg, a nitrogen content of about 2500 mg/kg and a halogen content of about 6 mg/kg.

### Example 5

51.9 g pyrolysis oil 1 and 2.50 g of an adsorption material in the form of molecular sieve 13X, obtained under the trade name Alfa Aesar™ from Fischer Scientific GmbH, 58239 Schwerte, Germany, are placed in an autoclave reactor. The autoclave reactor is hermetically sealed and a temperature of about 375° C. is applied for about 2 hrs. The process is performed under a nitrogen pressure of about 80 bar. Before the hydrogen pressure is applied, the autoclave reactor is heated to about 375° C.

After this treatment, the pyrolysis oil is filtrated at a temperature of about 70° C. with a filter, preferably having an average mesh size of about 6 μm, presently under pressure.

The resulting pyrolysis oil has a sulfur content of about 5900 mg/kg, a nitrogen content of about 2800 mg/kg and a halogen content of about 15 mg/kg.

### Example 6

57.8 g pyrolysis oil 1 and 2.50 g of an adsorption material in the form of a molecular sieve 3A, obtained under the trade name ACROS Organics™ from Fischer Scientific GmbH, 58239 Schwerte, Germany, are placed in an autoclave reactor. The autoclave reactor is hermetically sealed and a temperature of about 375° C. is applied for about 2 hrs. The process is performed under a hydrogen pressure of about 80 bar. Before the hydrogen pressure is applied, the autoclave reactor is heated to about 375° C.

After this treatment, the pyrolysis oil is filtrated at a temperature of about 70° C. with a filter, preferably having an average mesh size of about 6 μm, presently under pressure.

The resulting pyrolysis oil has a sulfur content of about 5500 mg/kg, a nitrogen content of about 3200 mg/kg and a halogen content of about 14 mg/kg.

As can be seen from Examples 1 to 6, the halogen content is drastically reduced upon a temperature treatment of the pyrolysis oil and by contacting the pyrolysis oil with an adsorption material.

Furthermore, the Examples show that the halogen content can be further reduced if a gas pressure is applied.

Different adsorption materials can be used in order to enhance the dehalogenation.

### Example 7

51.0 g pyrolysis oil 2 and 2.60 g of an adsorption material in the form of a molecular sieve 13X, obtained under the trade name Alfa Aesar™ from Fischer Scientific GmbH, 58239 Schwerte, Germany, are placed in an autoclave reactor. The autoclave reactor is hermetically sealed and a temperature of about 375° C. is applied for about 2 hrs. The process is performed under inherent pressure (without applying any gas pressure).

After this treatment, the pyrolysis oil is filtrated at a temperature of about 70° C. with a filter, preferably having an average mesh size of 6 μm presently under pressure.

The resulting pyrolysis oil has a halogen content of about 20 mg/kg.

### Example 8

50.5 g pyrolysis oil 2 and 2.50 g of an adsorption material in the form of Silica-alumina hydrate having an increased amount of Bronsted-acidic-sites, obtained under the product name SIRAL® 40 from Sasol Performance Chemicals, 20537 Hamburg, Germany, are placed in an autoclave reactor. The autoclave reactor is hermetically sealed and a temperature of about 375° C. is applied for about 2 hrs. The process is performed under inherent pressure (without applying any gas pressure).

After this treatment, the pyrolysis oil is filtrated at a temperature of about 70° C. with a filter, preferably having an average mesh size of 6 μm presently under pressure.

The resulting pyrolysis oil has a halogen content of about 35 mg/kg.

### Example 9 (Reference Example Regarding the Adsorption Material)

50.0 g pyrolysis oil 2 and no adsorption material is placed in an autoclave reactor. The autoclave reactor is hermetically sealed and a temperature of about 375° C. is applied for about 2 hrs. The process is performed under inherent pressure (without applying any gas pressure).

After this treatment, the pyrolysis oil is filtrated at a temperature of about 70° C. with a filter, preferably having an average mesh size of 6 μm presently under pressure.

The resulting pyrolysis oil has a halogen content of about 57 mg/kg.

A comparison between Examples 7 and 8 and Example 9 shows that the dehalogenation can be drastically enhanced by the use of an adsorption material.

### Example 10

51.1 g pyrolysis oil 2 and 2.50 g of an adsorption material in the form of a molecular sieve 13X, obtained under the trade name Alfa Aesar™ from Fischer Scientific GmbH, 58239 Schwerte, Germany, are placed in an autoclave reactor. The autoclave reactor is hermetically sealed and a temperature of about 375° C. is applied for about 2 hrs. The process is performed under a hydrogen pressure of about 80 bar. Before the hydrogen pressure is applied, the autoclave reactor is heated to about 375° C.

After this treatment, the pyrolysis oil is filtrated at a temperature of about 70° C. with a filter, preferably having an average mesh size of 6 μm presently under pressure.

The resulting pyrolysis oil has a sulfur content of about 5100 mg/kg, a nitrogen content of about 2700 mg/kg and a halogen content of about 9 mg/kg.

### Example 11

51.5 g pyrolysis oil 2 and no adsorption material are placed in an autoclave reactor. The autoclave reactor is hermetically sealed and a temperature of about 375° C. is applied for about 2 hrs. The process is performed under a hydrogen pressure of about 80 bar. Before the hydrogen pressure is applied, the autoclave reactor is heated to about 375° C.

After this treatment, the pyrolysis oil is filtrated at a temperature of about 70° C. with a filter, preferably having an average mesh size of 6 μm presently under pressure.

The resulting pyrolysis oil has a halogen content of about 34 mg/kg.

The comparison between Example 7 and Example 10 illustrates that the reduction of the halogen content is increased if a gas pressure in the form of hydrogen pressure is applied compared to the process performed under inherent pressure (with the same adsorption material). The comparison between Example 10 and Example 11 illustrates that the reduction of the halogen content is even enhanced if an adsorption material is used and hydrogen pressure is applied compared to no adsorption material being used.

### Example 12

49.5 g pyrolysis oil 2 and no adsorption material are placed in an autoclave reactor. The autoclave reactor is hermetically sealed and a temperature of about 375° C. is applied for about 2 hrs. The process is performed under a nitrogen pressure of about 80 bar. Before the nitrogen pressure is applied, the autoclave reactor is heated to about 375° C.

After this treatment, the pyrolysis oil is filtrated at a temperature of about 70° C. with a filter, preferably having an average mesh size of 6 μm presently under pressure.

The resulting pyrolysis oil has a halogen content of about 44 mg/kg.

The comparison of Example 11 and Example 12 illustrates that using hydrogen pressure leads to an even enhanced reduction of the halogen content compared to using nitrogen pressure.

### Example 13

50.0 g pyrolysis oil 3 and 2.60 g of an adsorption material in the form of a spent catalyst, obtained from fluid catalytic cracking (spent FCC catalyst), are placed in an autoclave reactor. The autoclave reactor is hermetically sealed and a temperature of about 375° C. is applied for about 2 hrs. The process is performed under inherent pressure (without applying any gas pressure).

After this treatment, the pyrolysis oil is filtrated at a temperature of about 70° C. with a filter, preferably having an average mesh size of about 6 μm, presently under pressure.

The resulting pyrolysis oil has a sulfur content of about 300 mg/kg, a nitrogen content of about 8900 mg/kg and a halogen content of about 160 mg/kg.

Example 13 illustrates that spent FCC catalyst can be used as adsorption material for an enhanced dehalogenation.

### Example 14

49.7 g pyrolysis oil 3 and 2.52 g of an adsorption material in the form of activated charcoal, obtained from Merck KGaA, 64271 Darmstadt, Germany, are placed in an autoclave reactor. The autoclave reactor is hermetically sealed and a temperature of about 375° C. is applied for about 12 hrs. The process is performed under a hydrogen pressure of about 80 bar.

After this treatment, the pyrolysis oil is filtrated at a temperature of about 70° C. with a filter, preferably having an average mesh size of about 6 μm, presently under pressure.

The resulting pyrolysis oil has a sulfur content of about 100 mg/kg, a nitrogen content of about 7600 mg/kg and a halogen content of about 60 mg/kg.

### Example 15

50.1 g pyrolysis oil 3 and 2.52 g of an adsorption material in the form of activated charcoal, obtained from Merck KGaA, 64271 Darmstadt, Germany, are placed in an autoclave reactor.

The autoclave reactor is hermetically sealed and a temperature of about 375° C. is applied for about 2 hrs. The process is performed under a hydrogen pressure of about 80 bar.

After this treatment, the pyrolysis oil is filtrated at a temperature of about 70° C. with a filter, preferably having an average mesh size of about 6 μm, presently under pressure.

The resulting pyrolysis oil has a sulfur content of about 300 mg/kg, a nitrogen content of about 8400 mg/kg and a halogen content of about 110 mg/kg.

### Example 16

50.2 g pyrolysis oil 3 and 2.60 g of an adsorption material in the form of Molecular sieve 3A, obtained under the trade name ACROS Organics™ from Fischer Scientific GmbH, 58239 Schwerte, Germany, are placed in an autoclave reactor. The autoclave reactor is hermetically sealed and a temperature of about 375° C. is applied for about 12 hrs. The process is performed under a hydrogen pressure of about 80 bar.

After this treatment, the pyrolysis oil is filtrated at a temperature of about 70° C. with a filter, preferably having an average mesh size of about 6 μm, presently under pressure.

The resulting pyrolysis oil has a halogen content of about 55 mg/kg.

The comparison between Example 14, Example 15 and Example 16 illustrates that an increased reaction time improves the dehalogenation, independent of the choice of adsorption material.

### Example 17

50.0 g pyrolysis oil 3 and 2.51 g of an adsorption material in the form of an alumina material, obtained under the product name CL-750 (containing alumina, a surface modifier and 0.015 wt.-% silica) from BASF Corporation, Iselin, New Jersey, 08830, USA, are placed in an autoclave reactor. The autoclave reactor is hermetically sealed and a temperature of about 375° C. is applied for about 2 hrs. The process is performed under inherent pressure (without applying any gas pressure).

After this treatment, the pyrolysis oil is filtrated at a temperature of about 70° C. with a filter, preferably having an average mesh size of about 6 μm, presently under pressure.

The resulting pyrolysis oil has a sulfur content of about 300 mg/kg, a nitrogen content of about 8500 mg/kg and a halogen content of about 140 mg/kg.

Example 17 illustrates that the dehalogenation is enhanced also with alumina-based adsorption materials.

In summary, the Examples described above, illustrate the following features:
the use of various adsorption materials results in an improved dehalogenation;
the performance of the process under gas pressure (either hydrogen or nitrogen), for example about 80 bar, results in an improved dehalogenation;
the performance of the process under hydrogen pressure is even better than under nitrogen pressure;
a prolonged reaction time, for example about 12 hrs., results in an improved dehalogenation;
the thermal treatment, for example at about 375° C., of pyrolysis oil results in an improved dehalogenation;
the process can be successfully performed for pyrolysis oils with different initial halogen content.

1.-15. (canceled)

16. Process for purifying a pyrolysis oil originating from pyrolysis of plastic waste, wherein the process comprises a dehalogenation of the pyrolysis oil, wherein the dehalogenation comprises:
contacting the pyrolysis oil with one or more adsorption material and/or
subjecting the pyrolysis oil to a temperature of about 280° C. or more,
wherein a halogen content of a resulting purified pyrolysis oil is about 55% or more lower compared to the halogen content of the untreated pyrolysis oil.

17. Process according to claim 16, wherein the dehalogenation is performed in a reaction chamber at a gas pressure of about 10 bar or more.

18. Process according to claim 16, wherein the dehalogenation is performed for about 2 minutes or more.

19. Process according to claim 16, wherein a weight ratio between the pyrolysis oil and the one or more adsorption materials is about 10:1 or more.

20. Process according to claim 16, wherein one or more of the one or more adsorption materials is a molecular sieve or a zeolite.

21. Process according to claim 16, wherein the temperature during the dehalogenation is about 300° C. or more.

22. Process according to claim 16, wherein one or more of the one or more adsorption materials is a particulate material.

23. Process according to claim 16, wherein one or more of the one or more adsorption materials has one or more of the following properties:
an average pore volume of about 0.2 ml/g to about 2.0 ml/g; and/or
an average pore size of about 1 Å to about 15 Å.

24. Process according to claim 16, wherein the process is a continuous and/or automatically controllable process and/or wherein in case the pyrolysis oil is waxy the pyrolysis oil is preheated in a preheating device before it is supplied to a reaction chamber.

25. Use of a purified pyrolysis oil obtained by a process in accordance with claim 16 as feedstock for a cracker, preferably a steam cracker, or as feedstock for a partial oxidation unit to produce syngas.

26. Purification system for purifying pyrolysis oil originating from pyrolysis of plastic waste, wherein the purification system comprises:
a reaction chamber for accommodating pyrolysis oil and/or one or more adsorption materials;
a pyrolysis oil supply for supplying pyrolysis oil into the reaction chamber;
a temperature control element for adjusting the temperature of the pyrolysis oil in the reaction chamber to a temperature of about 280° C. or more,
wherein the purification system is designed and/or arranged in such a way that a halogen content of a resulting purified pyrolysis oil is after purification about 55% or more lower compared to the halogen content of the untreated pyrolysis oil.

27. Purification system according to claim 26, wherein the reaction chamber is part of a reactor, and/or wherein the temperature control element comprises at least one heating element for adjusting the temperature of the pyrolysis oil in the reaction chamber.

28. Purification system according to claim 26, wherein the purification system comprises a preheating device, wherein the preheating device is in a direction of flow of the pyrolysis oil arranged upstream of the reaction chamber and/or wherein the preheating device is fluidically connected with the reaction chamber.

29. Purification system according to claim 26, wherein the purification system comprises one or more conveying elements, for transporting the pyrolysis oil through the purification system.

30. Purification system according to claim 26, wherein the purification system comprises a pressurizing system for application of a controlled gas pressure in the reaction chamber,
wherein the pressurizing system comprises one or more gas lines which are fluidically connected with the reaction chamber.
